(19) United States
(12) Patent Application Publication
(10) Pub. No.: US 2006/0289019 A1
(43) Pub. Date: Dec. 28, 2006

(54) Information method and system for generating data for optimizing a medical treatment, and equipment used in this system

(75) Inventors: Franck Marchand, Montreal (CA); Nicolas Roux, Montreal (CA); Patrick Rambaud, Montreal (CA)

Correspondence Address: YOUNG & THOMPSON, 745 SOUTH 23RD STREET, 2ND FLOOR, ARLINGTON, VA, 22202, US

(73) Assignee: IPPM HOLDING SA

(21) Appl. No.: 11/194,587

(22) Filed: Aug. 2, 2005

(30) Foreign Application Priority Data
Jun. 24, 2005 (FR) 05 06484

(51) Int. Cl. G06F 19/00

(52) U.S. Cl. 128/898; 702/20; 702/19

(57) ABSTRACT

The aim of the invention is to optimize a medical treatment administered to a patient as well as to propose a choice of alternative medical treatments, as a function of the genotype of the patient, of the potential interactions between drugs, of the genes involved in the medical mechanism and of the information and diagnostics concerning the patient. It uses a method for generating data for optimizing a medical treatment, implemented in computing equipment, comprising the following stages: acquisition of data relating to the medical treatment envisaged for a patient, acquisition of data relating to the genotype of the patient, acquisition of data relating to the lifestyle of the patient, identification, from said acquired data and from a knowledge base containing pharmacogenetic information, of potential pharmacogenetic interactions in the case of said treatment, identification, from the potential interactions identified, of at least one optimization of said treatment, and provision of data for optimizing said treatment. The method is based on multi-objective optimization techniques, applied to pharmacogenetics, linked to an information system for recovering data for clinical updates. The invention relates to a knowledge base and a pharmacogenetic and pharmacogenomic information system, applied to the gene-drug interactions and to the choice of treatments. The invention relates also to a drug regimen optimizer based on multi-objective algorithm applied through service oriented architecture.

The present invention relates to a method for generating data for optimizing a medical treatment. It also relates to an information system for generating optimizing data, using the method according to the invention, and computing equipment in which this method is implemented.

This invention is more particularly aimed at a method for correlating pharmacogenetic, pharmacological and medical data, in order to determine the best treatment for a patient.

The field of the invention is the medical field. During a medical treatment, doctors seek to avoid drugs which can produce undesirable reactions. These undesirable reactions can be interactions between drugs in the case where the medical treatment comprises several drugs or reactions caused by the drug on the patient directly. Among the latter type of reactions, there may be mentioned, for example, the allergy that a living organism can have to a drug. Moreover, the effectiveness of a drug changes depending on the people who use it. Thus, scientists estimate that 90% of drugs only work in 30 to 50% of the population. It is therefore important to consider an individual's response to a treatment before the treatment is administered to him. Otherwise the effectiveness of the treatment can be compromised.

In another way, a patient's medical history can necessitate a very intense medical treatment. In fact, according to the patient's genotype, doctors can establish an effective treatment with several drugs. But these drugs can themselves interact. The greater the number of drugs, the greater the chances of interactions between the drugs. It is therefore, in practice, very difficult to find the best medical treatment having no, or the least possible, interaction between drugs. This problem of finding the best possible medical treatment manifests itself in the United States as the fourth cause of mortality according to the studies carried out by the “Centre for Disease Control Fastats”.

Following genetic testing of their patient, doctors currently have a summary of the interactions between the genes and the drugs according to the genotype of the patient. Thus the doctor can adjust the treatment in terms of the doses and the intake prescribed or even changing drugs in order to ensure better medication for his patient. But depending on the patient and his genotype in relation to a drug, the medical treatment can be composed of several drugs which can themselves interact. It is therefore very difficult in practice for the doctors to find the best medical treatment having no, or the least possible, drug interactions.

Moreover, interactions between drugs are known and the information which accompanies the drugs informs doctors of their undesirable effects. However, managing this information is very complicated in the case of treatments involving many drugs.

Finally, information systems exist for informing doctors of possible adverse reactions, such as the system disclosed in the publication US2003/0104453A1.

The existing information systems independently process two categories of information which are the interactions between drugs and the gene-drug interactions. Moreover, these systems are complex and are not simple tools which could guide the doctor in his therapeutic choices.

By pharmacogenetic knowledge base, is understood a base where a set of medical, genetic and pharmaceutical information is stored. Amongst this information, a description of drugs can be found which seeks to constitute the most comprehensive characterization possible of these drugs, of their working and of their undesirable effects, and all the medical data relating to these drugs which are contained in the scientific bases.

Therefore, an objective of the invention is to propose a combined and comprehensive study of the pharmacogenetic (pharmacogenomic) drug and gene-drug interactions in order to guide the doctor in his therapeutic choices in order to find the best treatment corresponding to each genetically tested patient.

The invention proposes a method for generating data for optimizing a medical treatment, implemented in computer equipment, comprising the following stages:
acquisition of data relating to the medical treatment envisaged for a patient,
acquisition of data relating to the patient's genotype,
acquisition of data relating to the patient's lifestyle,
identification, from said acquired data and from a knowledge base containing pharmacogenetic information, of potential pharmacogenetic interactions in the case of said treatment,
identification, from the potential interactions identified, of at least one optimization of said treatment, and
provision of data for optimizing said treatment.

A combined and comprehensive study of the interactions between drugs and of gene-drug interactions, with a view to optimizing the medical treatment administered to a patient, constitutes a new approach in personalized medicine. This approach, because of its complexity in managing a very large quantity of information, is the most comprehensive currently available in the field of medicine.

Thus, only the method according to the invention makes it possible to deal with the fact that not only can a drug interact with other drugs but it may not be suited or may be more suited to the metabolism of a given patient according to the phenotype of the latter and can also induce or inhibit an enzyme(s) and/or protein(s) involved in the biotransformation of xenobiotics.

The invention is particularly useful as it allows the establishment of a personalized and comprehensive medical treatment for each patient taking account of a great number of pharmacogenetic (pharmacogenomic) interactions including the drug and gene-drug interactions in a manner so as to avoid all interactions, whether they be the product of the drugs or the product of the genetic behaviour of the patient to the drugs or also a combination of reactions which are the product both of the drugs or of the genetic behaviour.

The method according to the invention advantageously allows the doctor to be guided right through the process of deciding the composition of the final medical treatment from the envisaged medical treatment by helping him throughout the decision making process and in the choices to be made.

The method according to the invention advantageously allows inclusion of the data contained in the scientific literature and the results of the scientific and genetic testing by means of the pharmacogenetic knowledge base, so as to have the most comprehensive information base possible in order to detect the potential interactions during a medical treatment. Thus, a maximum number of interactions can be detected for maximum optimization.

Moreover, the method according to the invention advantageously allows confirmation of the therapeutic choice. In fact, the method can be implemented in order to detect any interactions, but also in order to confirm a choice of medical treatment as being the optimum treatment.

The method according to the invention advantageously allows the combination of personal data, such as data on the genotype and on the lifestyle of the patient, with data from the pharmacogenetic knowledge base in order to adapt the optimization of the medical treatment to the patient concerned by the treatment.

Thus the method according to the invention proposes, for a medical treatment, a more suitable combination of drugs than that proposed by the doctor or confirmation that the combination of drugs proposed by the doctor is the most suitable. For this purpose, the method according to the invention will try to find the best compromise taking into account several criteria or objectives. One objective would be, for example, to limit the inhibitions on one gene in particular. However it is also necessary to consider that the objectives can interact between each other and minimizing or maximizing one criterion can produce the modification of other factors relating to other objectives. The optimization realized is a evolutionary multicriteria optimization.

The objectives of the method according to the invention are the minimizing of certain criteria relating to the medical treatment of a patient. These criteria are associated with functions whose variables are variables from the scientific field, such as the concentration of a product in plasma or the KI of a molecule. A vector is associated with each variable such as:
x=(x₁, . . . , xₙ) such as ∀xxᵢ^{l}<xᵢ<xᵢ^{h} with

xᵢ^{l}: Lower limit of the variable xᵢ

xᵢ^{h}: Upper limit of the variable xᵢ
The problem of multicriteria optimization can then be expressed as:

$$\{ \begin{matrix}min {f}_{m} ( x ) & m = 1 , … , M \\ {g}_{j} \leq 0 & j = 1 , … , K \\ {h}_{j} = 0 & j = K + 1 , … , L\end{matrix}$$

All of the functions ƒₘ must be minimized by respecting the constraints of inequality and of equality expressed over gⱼ and hⱼ. This optimization system will find a set of compromises which will be a set of combinations of quantitative values. This set resulting from the multicriteria optimization algorithm is also called the Pareto set. The term <<evolutionary>> means that the method for finding the set of solutions is a genetic algorithm which reproduces an evolutionary process similar to that described by Darwin for finding the best compromises in the field of achievable solutions. The thesis, entitled Application of the evolutionary algorithms to the problems of multi-objective optimization with constraints, supported by Olga Rudenko on the 5th Mar. 2004, provides greater explanation of this subject.

This Pareto set is then subjected to a process called the <<decision-maker>>. The latter allows the combination of drugs closest to the compromises found by the multicriteria algorithm to be chosen. It corresponds to the final phase of the process of selecting a suitable treatment. The drugs which are able to be selected are those present in a list of drugs defined previously. These drugs should be documented as regards the quantitative values linked to the input variables of the problem of multicriteria optimization. Otherwise no correlation can be made between an element of the Pareto set and a drug from the list.

The data relating to the medical treatment envisaged for the patient can advantageously comprise data on the name and on the intake of the drugs which compose the initial treatment as well as the intake and the duration of the treatment. This advantageously makes it possible to take into account all the data on the medical treatment envisaged and optimization to be carried out on a maximum of points.

The data relating to the genotype of the patient can include information on transporters and receptors involved in genetic metabolization of drugs.

The data relating to the genotype of the patient can include information on the genes involved in the production of the cytochrome P450 enzymes. In fact, the cytochrome P450 plays a significant role in the metabolism of xenobiotics and more than half of the 200 most prescribed drugs in the United States are metabolized by the cytochrome P450 enzymes. Moreover, genetic studies today mostly relate to the polymorphism of this cytochrome.

The information on the genes involved in the production of the cytochrome P450 enzymes states the nature and the combination of alleles of these genes for the patient. It is this information on the nature and the combination of alleles which will lead to the determination of a predictive phenotype for the patient, indicating the attitude of the patient in the metabolization of a drug metabolized by the cytochrome P450 enzymes.

The gene-drug interactions, taken into account in the method according to the invention, are defined by the phenotype of the patient for the enzyme metabolizing this drug.

According to the genotype and the (xenobiotic) substrates for the enzymes concerned, several phenotypes are determined with their clinical implications:
Certain genotypes lead to a deficiency of the enzyme. The enzyme is inactive or the corresponding gene is absent. The individuals concerned are so-called <<Poor Metabolizers>>: PM. They thus have a high risk of being intoxicated by the drugs.
Other genotypes, in the case of duplicated genes, increase the activity of the enzyme. The individuals concerned are so-called <<Ultra-rapid Metabolizers>>: UM. They can thus have a resistance to medical treatment.
Certain genotypes, in the case where the gene is not functional, lead to a decrease in the enzymatic activity. The individuals concerned are so-called <<extensive metabolizers with diminished activity>>: EM dim, or <<Intermediate Metabolizers>>: IM.
However, the most common genotype in the population, considered as the wild genotype, corresponds to the phenotype of <<Extensive Metabolizers>>: EM.

The cytochrome P450 enzymes which are most often found are the following: CYP1A2, CYP2C19, CYP2C9, CYP2D6, CYPNAT2 and CYP3A4. These enzymes occur either as human isoenzymes of the cytochrome for the metabolization of the drugs, or as enzymes involved in the biotransformation of xenobiotics.

The human isoenzymes of this cytochrome, which have a substantial genetic polymorphism playing a role in the metabolization of the drugs, are: CYP2C9, CYP2C19, CYP2D6.

The optimization of a medical treatment according to the invention can comprise an optimization according to the genotype of the patient for the genes constituting the HLA system. In fact, the information relating to the genotype of the patient can include information on the genotype of the patient for the genes of the HLA system. Such an optimization is very advantageous as the genes of the HLA system are recognized as being the genetic markers for a person's susceptibility to diseases, allergies, infections, for his auto-immunity, etc. In addition to the HLA genes of class I and class II, other loci in the region of the HLA system influence certain of these factors. These loci are subject to new treatments, in particular immunobiotherapies. Moreover, the HLA system is involved in the response to vaccines, grafts and in undesirable reactions to numerous drugs. It is therefore very important to be able to optimize a medical treatment administered to a patient taking account of the HLA system of the patient.

Advantageously, the medical treatment can comprise at least one drug utilized in a cancer treatment. Thus the invention has the potential to offer individualized cancer treatment regimens.

For example, genetic variations in the TPMT (thiopurine S-methyltransferase) b gene have profound effects on the bioavaibility and toxicity of 6-Mercaptopurine (6-MP: purine antimetabolite used in the treatment of leukaemia). Patients who carry TPMT polymorphisms are at risk for severe hematologic toxicities when treated with 6-MP because these polymorphisms lead to a decrease in the rate of 6-MP metabolism. Three particular TPMT alleles: TPMT*2, TPMT*3A and TPMT*3C have been shown to account for nearly 95% of the observed cases of TPMT deficiency. Each of these mutant alleles encodes TPMT proteins that undergo rapid degradation, leading to enzyme deficiency. A recent trial estimated that 71% of patients with bone marrow intolerance to 6-MP were phenotypically TPMT deficient and that these patients were more likely to be hospitalized, receive platelet transfusions, and miss scheduled doses of chemotherapy. Appropriate 6-MP dose reductions for TPMT-deficient patients have allowed for similar toxicity and survival outcomes as patients with normal TPMT levels.

Similarly, Irinotecan (Camptosar®; Pfizer Pharmaceuticals) has potent antitumor activity against a wide range of tumors, and it is one of the most commonly prescribed chemotherapy agents. Diarrhea and myelosuppression are however, the dose-limiting toxicities of irinotecan and interfere with optimal utilization of this important drug. Studies of the clinical pharmacogenetics of irinotecan have been mainly focused on polymorphisms in UDP-glucuronosyltransferase 1A1 (UGT1A1), the enzyme for glucuronidation of SN-38 (Irinotecan active metabolite) to form the less toxic, inactive metabolite SN38G. The presence of seven TA repeats (referred to as UGT1A1*28), instead of the wild-type number of six, results in reduced UGT1A1 expression and activity. UGT1A1*28 has been shown to be associated with reduced glucuronidation of SN-38, increased exposure to SN-38, and increased clinical toxicity for patients treated with irinotecan. Clinical trials are ongoing or planned to address the impact of dose on irinotecan safety in patients with different UGT1A1*28 genotypes.

Another example is the case of Dihydropyrimidine dehydrogenase (DPD). Dihydropyrimidine dehydrogenase catalyzes the rate-limiting step in 5-FU (5-fluorouracil: some of the most commonly prescribed chemotherapy agents) catabolism; therefore, variability in this enzyme activity is one of the major factors that influences systemic exposure to fluorodeoxyuridine monophosphate (FdUMP) and the incidence of adverse effects to 5-FU. DPD deficiency appears to be a genetic disorder arising from multiple polymorphisms in the DPYD gene resulting in decreased enzyme activity. One of the primary mechanisms of action of 5-FU is the inhibition of thymidylate synthase (TS) by FdUMP. TS is an essential precursor of thymidine triphosphate, which is required for DNA synthesis and repair. TS inhibition is an important target for 5-FU as well as other folate-based antimetabolites, and clinical resistance to these TS-targeted therapies has been linked to overexpression of TS in tumor. TS expression levels in vivo appear to be regulated by the number of polymorphic tandem repeats in the TS enhancer region (TSER), where increases in TS expression and enzyme activity have been observed with increasing copies of the tandem repeats. Clinical studies have demonstrated that individuals who were homozygous for the TS promoter alleles TSER*3 (three tandem repeats) had significantly higher TS mRNA expression levels in tumor tissue than those with TSER*2 (two tandem repeats) and that these findings correlated with a lower response rate to 5-FU. These studies and another suggest that TSER genotyping may be useful in selecting patients who are likely to respond to treatment with 5-FU or its analogues.

Moreover, genetic variations in the MDR1 gene, which encodes P-glycoprotein (PGP) have been correlated with drug exposure of some commonly prescribed drugs such as digoxin and fexofenadine. Multiple MDR1 polymorphisms have been described to occur in various allelic combinations. Many studies evaluate the relationship between allelic variations in MDR1 and chemotherapy disposition and response.

Protein kinase mechanisms are used in signal transduction for the regulation of enzymes. Protein kinase polymorphisms appear important in the responsiveness to cancer treatment. EGFR (Epidermal Growth Factor Receptor), ERBB2, BRAF and KRAS2 genes are the most studied. Many studies show EGFR polymorphisms make the disease more responsive to treatment with tyrosine kinase inhibitors. For example, in a study with 118 surgically or gefitinib-treated lung cancer patients, some of gefitinib-responsive patients had L858R, whereas one gefitinib-resistant patient had G719S. In another study, an association between the EGFR signalling pathway and the response of cancer cells to ionizing radiation has been reported. The data suggests that a polymorphic variant in the EGFR gene: HER-1 497K and EGFR intron 1 (CA)(n) polymorphisms may be potential indicators of radiosensivity in patients with rectal cancer treated with chemoradiation.

In addition to these important polymorphisms in the cancer treatment, there are other genes such as the FLT3 receptor tyrosine kinase, FCG3RA IgG Fc receptor, methylenetetrahydrofolate reductase (MTHFR), N-acetyl transferases, DNA repair enzymes XPD and XRCC1, aldehyde dehydrogenase, glutathione S-tranferase (GSTP1) and multi-drug resistance associated protein (MRP2).

Moreover, the method according to the invention advantageously comprises providing information on creating correlations of the data relating to interactions, in the form of a table in which the inputs represent the cytochrome P450 enzymes, the genotype of the patient in relation to these enzymes and names of the drugs.

The information on the lifestyle of the patient can comprise a medical history of the patient and information on the life habits of the patient namely, for example, whether he is a smoker or not. This allows information collected in the patient's medical history to be advantageously incorporated in optimizing his medical treatment. In this way the method according to the invention allows certain reactions specific to the patient to be avoided, such as allergies, which would not be detected during the genetic testing or in the scientific literature. The optimization of the medical treatment will thus be more comprehensive.

The optimization can advantageously be completed by the information on the lifestyle of the patient including information relating to his nutrition. Thus, it is possible to detect the interactions linked to the nutrition of the patient and to take measures to try to avoid them.

The pharmacogenetic knowledge base defined by the method according to the invention can advantageously be an on-board base. It can just as easily be a base contained in a fixed location and accessible via a network connection. Moreover, it can advantageously be updated in line with new pharmacogenetic tests, new scientific data or any other information which may be involved in one way or another in the optimization of a medical treatment.

The method allows the pharmacodynamic interactions to be taken into account in the optimization of a medical treatment. These interactions refer to the antagonistic or synergetic actions between the plants or drugs. This occurs when a substance effects the assimilation or the clinical effectiveness of another substance when two substances, or more, are taken together.

A synergetic action takes place when two substances have identical properties, thus increasing or multiplying their actions. An antagonist action signifies that it reduces or cancels the therapeutic effect. In this way the method according to the invention allows an optimization to be achieved so as not to have, in the same treatment, a drug or substance having the same target in order to avoid interactions.

The method according to the invention can advantageously include pharmacokinetic interactions. These interactions effect the capacity of the body to treat the absorption, distribution, the metabolism and the elimination of molecules, plants or drugs. The inclusion of these interactions in the method according to the invention allows an optimization of the medical treatment to be achieved in several respects:

1) Absorption

The speed and/or the extent of the absorption of the different substances can be modified by several factors, such as for example:
The change in intestinal pH: modification of the absorption and degradation properties of the substance of interest.
Chelation: formation of insoluble complexes which are not able to pass through the intestinal mucous membrane.
Modification of gastric emptying and of intestinal motility: the presence or the absence of food can effect the absorption of drugs, and the administration of prokinetic agent can reduce the absorption of the molecules with poor solubility or the absorption occurs only in a limited section of the intestine.

The optimization of the medical treatment in this case prevents a drug or another compound from significantly disturbing the intestinal absorption of the drugs prescribed.

2) Distribution

There is a modification when there is a displacement of the protein bond of a first compound by a second compound. This results in an increase in the plasma concentrations of the free (pharmacologically active) fraction of the first compound, and therefore a risk of toxicity for the patient.

The optimization in the medical treatment advantageously prevents a drug or another compound from significantly upsetting the distribution of the drugs prescribed.

3) Metabolism

Most of the metabolic reactions (i.e. from the biological conversion of a substance by one or more enzymatic systems) take place in the liver. The four main types of metabolic reactions are oxidation, reduction, hydrolysis (phase I reactions) and conjugation (phase II reactions). The metabolites can be active, inactive or toxic.

The interactions which take place at the level of the metabolism are of two types: inhibition or induction of the cytochrome P450, and genetic polymorphism:

3-1) Inhibition/Induction of Cytochrome P450 Enzymes

Most of the oxidation reactions of the drugs (phase I reaction) are catabolized by a superfamily of mixed-function oxygenases which is known as the cytochrome P450. The isoenzymes of cytochrome P450 (CYP) are mainly present in the liver, and they are the origin of a great number of significant pharmacokinetic drug interactions. Approximately 95% of all oxidations of drugs are catalyzed by the isoenzymes CYP1A2, CYP2C8/9, CYP2C19, CYP2D6, CYP2E1, CYP3A4/5.

A cytochrome P450-inhibiting drug, erythromycin for example, administered at the same time as another drug metabolized by the same isoenzyme of cytochrome P450 (such as cyclosporine) will inhibit the metabolism of this drug (with inactive metabolite), and therefore produce an increase in the plasma concentrations, with a risk of toxicity.

A cytochrome P450-inducing drug, rifampicin for example, administered at the same time as another drug metabolized by the same isoenzyme of cytochrome P450 (such as an oral contraceptive) will speed up the metabolism of this drug (with active metabolite), and therefore produce a reduction in the plasma concentrations, with a risk of therapeutic failure.

The method in this case allows optimizing of the medical treatment in order not to have in the medical treatment inducers or inhibitors of the same isoenzyme metabolizing the drugs prescribed, or, in order to change the medical treatment to avoid induction or inhibition.

3-2) Genetic Polymorphism

With reference to the phenotypes described above, the subjects having the allele leading to the <<normal>> enzyme are called rapid metabolizers, while those having the allele leading to the <<deficient>> enzyme are called poor metabolizers. However this difference only has a clinical effect if the metabolic pathway effected is a quantitatively important pathway for the elimination of the drug in question and if the therapeutic range of this drug is small.

The clinical effect can be of two types in poor metabolizers: risk of toxicity for the drugs inactivated by the cytochrome in question; risk of therapeutic ineffectiveness for the drugs which require an activation by this same cytochrome in order to be active.

The method according to the invention advantageously allows optimizing of the medical treatment as a function of the phenotype for each isoenzyme of the cytochrome P450, in order to avoid any undesirable reactions. It also allows optimizing of the medical treatment as a function of the genotype of the patient relating to phase I and II biotransformation enzymes.

4) Excretion

Drug interactions can alter the renal elimination of the drug. The main mechanisms responsible are:
Glomerular filtration rate: when there is displacement of the protein bond, the increase in the free fraction of the drug which has been displaced is followed by an increase in the glomerular filtration rate and therefore the excretion of this drug.
Tubular secretion: when two drugs using the same tubular secretion transporter are co-administered, there is competition between these two drugs, and therefore reduction in the renal elimination of the <<losing>> drug. For example, probenecid administered at the same time as penicillin prevents the tubular secretion of penicillin, which leads to an increase in the plasma concentrations of the antibiotic.
Tubular reabsorption and change in urinary pH: A change in urinary pH will alter the proportion of ionized/non-ionized molecules present at the level of the renal tubule. However, only the non-ionized molecules are reabsorbed passively. Consequently the renal clearance of the weak bases is increased by acidifying the urine, while that of the weak acids is increased by alkalinising the urine. The significance of this type of interaction is moderate or even weak, because very few drugs are excreted in an unchanged form in urine, most of them are converted beforehand into inactive metabolites by the liver.

The optimization of the medical treatment according to the method allows significant disturbance in the excretion of drugs to be avoided.

The data on the genotype of the patient can advantageously include information on transporters involved in a genetic metabolization of drugs. This information in particular relates to the genotype of the patient with regard to these transporters. Thus, the method according to the invention can include interactions relating to transporters involved in the metabolization of drugs.

Currently, the P-glycoprotein (P-gp) constitutes the most studied drug transporter.

This protein being strongly expressed in the organism and playing an important role in the intestinal absorption of the drugs and/or their distribution in the different cellular compartments, it can thus alter their plasma or intracellular concentrations and influence the response to treatment.

Currently, a genetic polymorphism is connected to a reduction in expression of P-gp and, as a result, of its activity.

It allows identification of three genotypes: wild homozygotes (normal expression), deficient homozygotes (weak expression) and heterozygotes (reduced expression).

These days, only the 3435 and 2677 sites of the genetic sequence encoding P-gp, give rise to the most interest because they have been associated with modifications in the expression of P-gp and/or kinetic variations.

The drugs which can induce or inhibit this transport protein must be taken into consideration, because the induction of the protein activity can compensate for being a deficient homozygote, can cause the activity of P-gp to be reduced in a wild homozygote and can make it normal in a heterozygote.

By contrast, the inhibition of the protein activity can render this activity nil or very reduced in a deficient homozygote or a heterozygote, and can also reduce this activity in a wild homozygote.

The method according to the invention can include an interaction relating to receptors involved in a metabolization of drugs. In fact, the data on the genotype of the patient can include information on these receptors and on the genotype of the patient in relation to these receptors. An optimization of the medical treatment as a function of the genotype of the receptors is possible thanks to the method according to the invention.

In order for there to be a therapeutic effect, the metabolized drug, once it has reached the receptor, must bind with the latter, in order for a signalling pathway to be started.

The polymorphism of the receptors is therefore also very important for the response to the treatment.

Since, according to the genetic variant the receptor can change its conformation with respect to the wild phenotype, thus the ligand (metabolite) binds with the receptor with an affinity which is not as good or no longer binds at all: there is then no cell transmission and therefore no therapeutic effect. The receptor can also be non-functional even if there is ligand/receptor interaction, i.e. the receptor is incapable of transmitting the information: there is no therapeutic effect.

Some drugs can induce or inhibit receptor activity, just like the transporters.

Currently, the scientific literature particularly emphasizes inhibition, i.e. the ligand (antagonist) blocks the binding site of the second ligand, or the ligand (antagonist) binds and produces a conformational change which leads to a loss of binding of the second ligand at its site.

Examples of receptors and transporters dealt with by the method according to the invention are serotonin receptors, serotonin, tryptophan, hydroxylase, G-protein beta3, apolipoprotein and E type 4 (ApOE-e4) transporters.

The method according to the invention comprises in particular the optimization of a medical treatment, and in particular of anti-cancer treatments as a function of the genotype of the genes of the protein kinases recognized as playing an essential role in cancer.

According to another aspect of the invention, computing equipment is proposed, used in the optimization of a medical treatment, comprising:
means for acquiring data relating to the medical treatment envisaged for a patient,
means for acquiring data relating to the genotype of the patient,
means for acquiring data relating to the lifestyle of the patient,
software means, arranged in order to identify, from said acquired data and from a pharmacogenetic knowledge base containing information on gene-drug and drug-drug interactions, potential drug-drug and/or gene-drug interactions in the case of said treatment, and
means for providing information for optimizing said treatment from the potential interactions identified.

The computing equipment can advantageously be portable equipment. It can be a laptop computer using the method according to the invention, in order that it can be more easily transported by the doctor. Moreover, a laptop computer has the characteristic of being equipment which is easy to use and which is commonplace. The acquisition means are means which are integrated in this equipment, such as a keyboard, a mouse or a touch screen equipped or not equipped with a pen. These acquisition means are in no way limitative.

The software means can be on-board or means downloaded for each use from a site accessible via a network of the internet type. They can, for example, comprise an inference engine.

The means for providing information can include means for displaying or viewing information. These means can advantageously be on-board or otherwise.

According to yet another feature of the invention, an information system is proposed for producing data for optimizing a medical treatment, comprising:
means for storing data on the genotype of a patient,
means for storing data on the lifestyle of the patient,
means for storing data on the medical treatment envisaged for the patient,
means for storing a pharmacogenetic knowledge base, and
computing equipment for optimizing the medical treatment administered to a patient.

The means for storage of data on the genotype of the patient are advantageously organized in the form of portable means such as a USB (Universal Serial Bus) memory stick, a floppy disk, an optical medium of the compact disk (CD) type, a zip disk, an electronic chip inserted or not into the patient's skin, or a card equipped with an electronic chip.

This allows storage of this data on media which can be easily transported. This makes it possible to benefit from the optimization of the medical treatment regardless of the location or of the doctor, as long as this doctor has suitable equipment.

Other advantages and characteristics will become apparent on examining the detailed description of en embodiment which is in no way limitative, and the attached drawings in which:

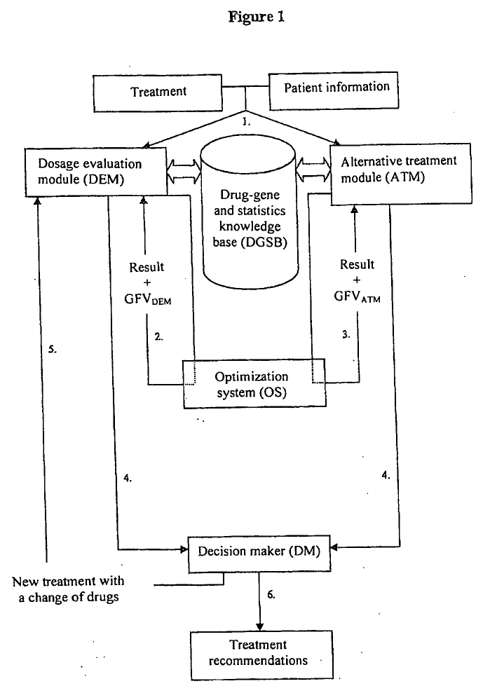

FIG. 1 shows an example of a block diagram of the method of generating optimizing data according to the invention;

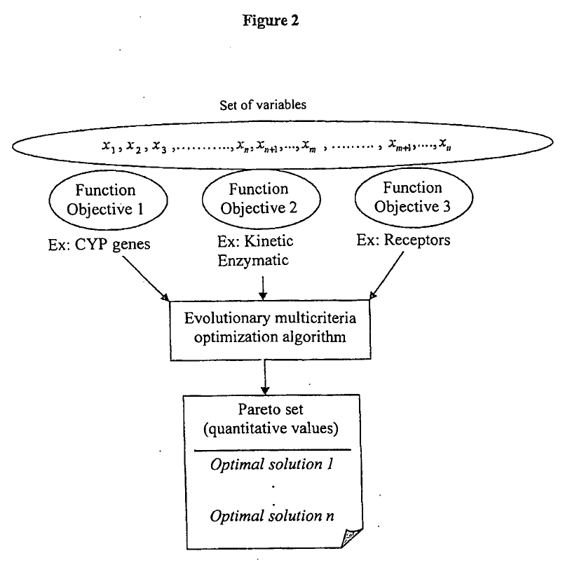

FIG. 2 describes an example of a global process of the optimization system, integrating the evolutionary multicriteria optimization;

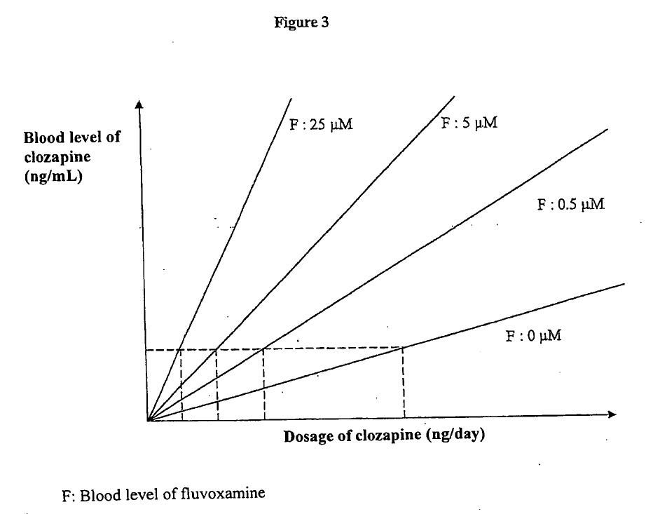

FIG. 3 describes, in the context of an example of optimization of medical treatment, the level of fluvoxamine in the blood;

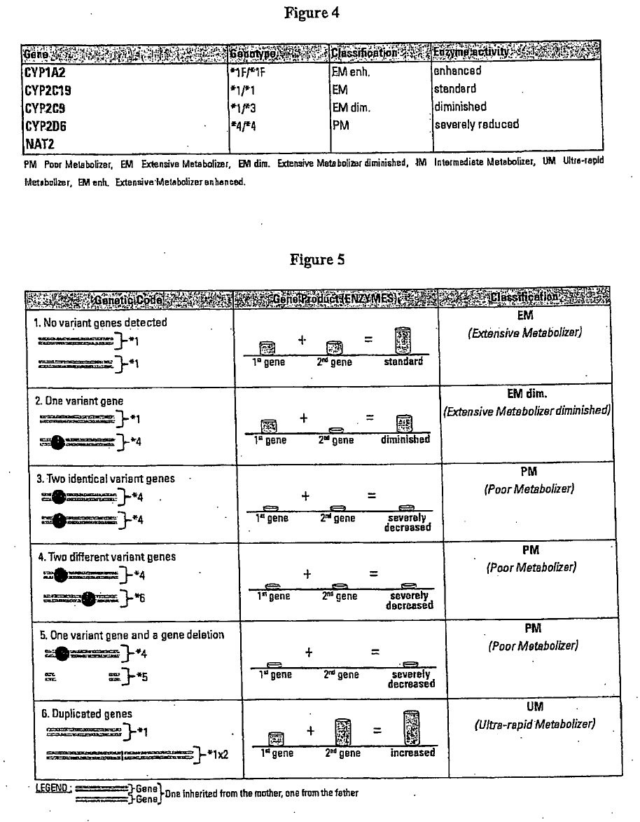

FIG. 4 describes an example of a patient's phenotype for each of the cytochrome P450 enzyme;

FIG. 5 describes a classification of phenotypes as a function of genotypes, as used in the method according to the invention;

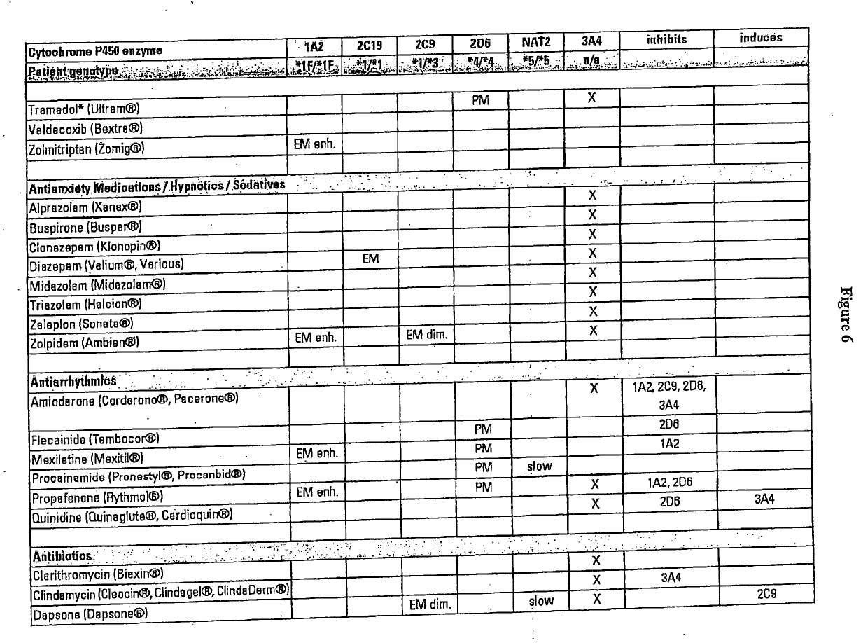

FIG. 6 describes an example of a correlation of the data on the genotype of the patient, his phenotype, the cytochrome P450 enzymes and the drugs, as used in the method according to the invention;

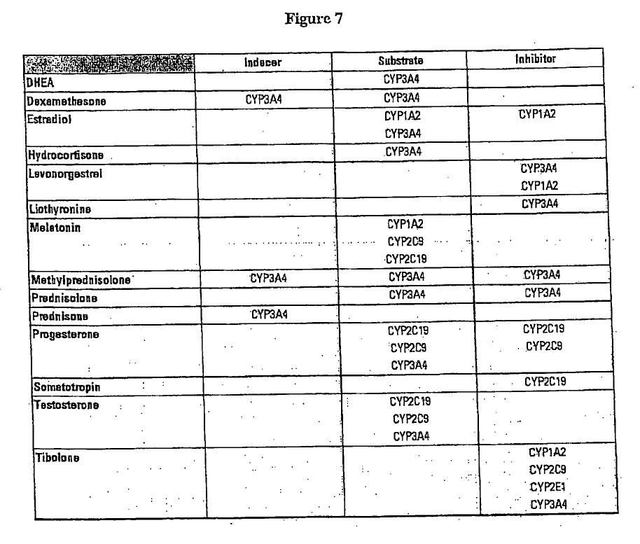

FIG. 7 describes an example of correlation of the hormones and of the cytochrome P450 enzymes, as used in the method according to the invention; and

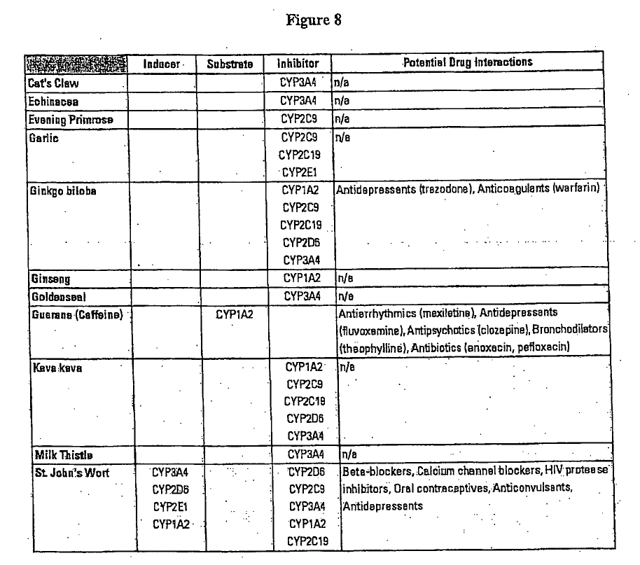

FIG. 8, describes an example of correlation of plants and of cytochrome P450 enzymes, as used in the method according to the invention.

There will now follow a non-limitative example, of the implementation of a method for generating data for optimizing a medical treatment administered to a patient according to the block diagram shown in FIG. 1.

A 37 year-old patient suffering from schizo-affective disorder and from dual personality disorder reacts correctly to clozapine (clozaril, 600 mg/day, blood concentration: 502 ng/mL). He is also treated with lithium (eskalith, 900 mg/day). After experiencing additional behaviour problems (washing his hands and hair every 10 minutes) the doctor decided to put him on fluvoxamine (luvox, 150 mg/day). After 11 days the patient had to be admitted to the emergency department because he had too high a blood level of clozapine (2112 ng/mL).

Fluvoxamine is a strong clozapine N-demethylation inhibitor, which corresponds to the main metabolization of clozapine. This means that by prescribing 150 mg/day of fluvoxamine, the doctor would greatly reduce the metabolic capacity of the patient for clozapine.

The system according to the invention will propose a more suitable treatment, if one exists, than that presently administered. Several means can be used to optimize the treatment. The first consists of changing the dosages of one or more drugs constituting the treatment. The second consists of changing one or more drugs among those used by the patient. The optimization of the treatment can be carried out in several stages:

1) With reference to FIG. 1, the current treatment and the patient's information are sent to the DEM (dosage evaluation module) and to the ATM (alternative treatment module) at the same time. The patient's information includes his genotype, his clinical history, and the different information relevant for the DEM and the ATM.

2) The DEM communicates with the DGSB (drug-gene and statistics knowledge base, or pharmacogenetic knowledge base) in order to obtain the pharmacogenetic data relating to the drugs taken by the patient. With reference to FIG. 2, the latter are transformed into a set of mathematical variables and functions (objectives), which can be understood by the OS (optimization system) and which is then sent to the latter. The OS will then try to optimize as much as possible the dosages of the different drugs by finding the best compromise. The result is then sent back to the DEM accompanied by a value GFV_{DEM} (global fitness value). This value is calculated by comparing the optimized result and the ideal result (which is impossible in reality considering all of the objectives to be satisfied). The result is a group of drugs identical to that of the treatment presently prescribed but with different dosages. The DEM can then verify the integrity of the result and carry out various post-optimization checks.

3) Then, according to a process similar to 2, the ATM (alternative treatment module) communicates with the DGSB, to obtain and transform the pharmacogenetic data in order to send it to the OS in a format suited to the latter. The result in this case will be a set of numerical values corresponding to the set of values of the optimal input variables. This result does not describe a new combination of drugs but the expression of a more suitable treatment as a function of the input variables of the OS. The DM (decision maker) serves, among other things, to choose the treatment corresponding to such numerical values.

4) The ATM and the DEM, after having carried out all the necessary checks, each send back their results as well as the respective GFVs to the DM. Another piece of information is sent: the signature. It specifies whether the result comes from the ATM (GFV_{ATM}) or from the DEM (GFV_{DEM}). The DM as a function of the GFVs will choose the result by comparing the various respective GFVs. The result with the greatest GFV defines the most valid result. If the signature of the result is that of the ATM, the DM will choose the combination of drug which best corresponds to the set of numerical variables of the result of the OS. This will thus result in a new treatment proposal.

5) This new treatment is sent back to the DEM with the standard dosages for each drug. The DEM will thus receive the patient's information again. A second iteration starting from phase 2 will be carried out. The information advising that this is a second iteration will be sent until the second passage of the DM. In this case the comparison between the GFVs is not carried out since the situation is for <<refining>> the result of the ATM.

6) Finally the final recommendation is sent. This will then be, either a new dosage of the different drugs of the treatment, or a new group of drugs with dosages suited to the patient.

Thus, the DEM will transfer the pharmacogenetic data from the DGSB. It will find, according to the pharmacokinetic data and studies on clozapine-fluvoxamine interaction, an appropriate function and the corresponding statistical values. In the present case, the function will be, as is shown in FIG. 3, the clozapine blood level as a function of the prescribed dose and of the fluvoxamine blood level. The clozapine blood level is that observed during a parallel treatment with fluvoxamine. The dosage of fluvoxamine is sought to be maintained constant. Still with reference to FIG. 3, the straight line which is of interest therefore, is that for which the blood level is 5 μM. In fact, the 150 mg/day of luvox produces this blood level of fluvoxamine. The equation of this straight line (according to data taken from a publication) is y=3.7×/1.8 [symbol] x=1.8y/3.7. Therefore if y=502 ng/mL then x=502*1.8/3.7=244 ng/mL. This means that the current dosage would need to be reduced by at least a half in order to avoid too great an interaction between the two products and especially to prevent a worrying blood level of clozapine in the blood. This optimization reasoning will be carried out by the OS as a function of the data which are sent to it by the DEM.

The present example of medical treatment is a specific case and is in no way limitative. If necessary, other factors could simultaneously be considered in the optimization, in order to obtain the best compromise while respecting several objectives. For example, the genotype of the patient, as shown in FIGS. 4 and 5, could have been taken into consideration in the optimization, in order to obtain an even more personalized dosage. An evaluation of the drugs category by category as shown by FIG. 6, as well as an evaluation of the interactions linked to the transporters and to the receptors could also be envisaged, if this proves to be necessary in the optimization. These interactions are detected thanks to the scientific information contained in the pharmacogenetic knowledge base.

In a similar way, all the inhibiting or reducing hormones of a cytochrome P450 enzyme in particular could be considered, if this were necessary. This consideration can be carried out through an evaluation of the hormones, as shown by FIG. 7.

The method according to the invention also allows inclusion of the interactions linked to plants. If necessary, these interactions can be considered by identifying the effects of the plants on the metabolism of the patient, as shown by FIG. 8.

The method, the device and the system according to the invention are not limited to the detailed example below and can be applied to any treatment, medical or otherwise, applied to living organisms.

1- Method for generating data for optimizing a medical treatment, implemented in computing equipment, comprising the following stages:
acquisition of data relating to the medical treatment envisaged for a patient,
acquisition of data relating to the genotype of the patient,
acquisition of data relating to the lifestyle of the patient, identification, from said acquired data and from a knowledge base containing pharmacogenetic information, of potential pharmacogenetic interactions in the case of said treatment, identification, from the potential interactions identified, of at least one optimization of said treatment, and
provision of data for optimizing said treatment.

2- Method according to claim 1, characterized in that it also comprises, following an identification of a plurality of optimizations, a stage of choosing from within said plurality.

3- Method according to claim 1, characterized in that the optimization is a multicriteria optimization.

4- Method according to claim 1, characterized in that the optimization is an evolutionary optimization.

5- Method according to any claim 1, characterized in that the data relating to the medical treatment envisaged for a patient includes the name and the dosage of the drugs in the context of said treatment.

6- Method according to claim 1, characterized in that the data relating to the genotype of the patient include information on the genes involved in the production of the cytochrome P450 enzymes.

7- Method according to claim 1, characterized in that the data relating to the genotype of the patient includes information on transporters and receptors involved in a genetic metabolization of drugs.

8- Method according to claim 1, characterized in that it also comprises the determination, from the nature and the combination of the alleles of the genes involved in the production of the cytochrome P450 enzymes, of a predictive phenotype indicating a particular attitude in the metabolization of a drug metabolized by said enzymes.

9- Method according to claim 5, characterized in that the cytochrome P450 enzymes concerned include CYP1A2, CYP2C19, CYP2C9, CYP2D6, CYPNAT2 and CYP3A4.

10- Method according to claim 1, characterized in that the information on the genotype of the patient includes data on the HLA system of the patient.

11- Method according to claim 1, characterized in that the information on the lifestyle of the patient includes a medical history of the patient.

12- Method according to claim 1, characterized in that the information on the lifestyle of the patient includes information concerning his nutrition.

13- Method according to claim 1, characterized in that the pharmacogenetic knowledge base is on-board.

14- Method according to claim 1, characterized in that it also comprises a remote consultation of the pharmacogenetic knowledge base via a network connection.

15- Method according to claim 1, characterized in that it also comprises updating of the pharmacogenetic base.

16- Method according to claim 1, including a pharmacodynamic interaction.

17- Method according to claim 1, including a pharmacokinetic interaction.

18- Method according to claim 1, including an interaction concerning transporters.

19- Method according to claim 1, including an interaction concerning receptors.

20- Method according to claim 6, characterized in that it also comprises providing information on the correlation of the data relating to the interactions, in the form of a table in which the inputs represent the cytochrome P450 enzymes, the genotype of the patient in relation to these enzymes and names of the drugs.

21- Method according to claim 1, characterized in that the medical treatment comprises at least one drug utilized in a cancer treatment.

22- Computing equipment, used for generating data for the optimization of a medical treatment, comprising:
means for acquiring data relating to the medical treatment envisaged for a patient, means for acquiring data relating to the genotype of the patient,
means for acquiring data relating to the lifestyle of the patient,
software means, arranged in order to identify, from said acquired data and from a knowledge base containing pharmacogenetic information, potential pharmacogenetic interactions in the case of said treatment, and
means for identifying at least one optimization of said treatment using the potential interactions identified, and
means for providing data for optimizing said treatment.

23- Computing equipment according to claim 22, characterized in that it is of the laptop type.

24- Computing system for generating data for optimization of a medical treatment, comprising:
means for storing data on the genotype of a patient,
means for storing data on the lifestyle of the patient,
means for storing data on the medical treatment envisaged for the patient,
means for storing a pharmacogenetic knowledge base, and
computing equipment for optimizing the medical treatment administered to a patient.

25- System according to claim 24, characterized in that the means for storing data on the genotype of the patient are organized in the form of a removable data storage medium.
